(19) United States
(12) Patent Application Publication
(10) Pub. No.: US 2006/0078106 A1
(43) Pub. Date: Apr. 13, 2006

(54) Self-dialing telephone directory

(76) Inventor: Charles Ray Willcox, Eden Prairie, MN (US)

Correspondence Address: Charles Ray Willcox, 16128 Baywood Lane, Eden Prairie, MN, 55346, US

(21) Appl. No.: 10/964,304

(22) Filed: Oct. 13, 2004

(51) Int. Cl. H04M 1/00; H04M 3/00

(52) U.S. Cl. 379/355.01; 379/355.02

(57) ABSTRACT

An apparatus intended for the elderly, handicapped, or very young, for automatically storing and dialing telephone numbers based on the selected page of an attached telephone directory. The telephone directory pages accommodate photos, names, or other memory cue information. The directory pages also incorporate specialized markers to uniquely identify each page so that a circuit capable of detecting the page markers is able to associate a telephone number with the particular page being viewed. In the preferred embodiment, telephone numbers are programmed into the apparatus by the user through the use of several memory buttons and an attached telephone. Once programmed, the user can turn to a desired page in the telephone directory and then place a call to the party being viewed by simply pressing a dial button.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of telephone communications and more specifically to an apparatus for automatically dialing telephone numbers based on the page selected from a telephone directory.

### HISTORY OF TECHNOLOGY

Since its inception, the telephone has evolved to provide increasing convenience and utility to its user. Recent improvements range from push button dialing to portable telephones that can be carried around the home or office while in use. Other improvements include the ability to save dialed numbers and then recall them by pushing a series of memory keys. These features can now be found on most telephones available today. Decoupled from the telephone itself, are telephone directories that can be as simple as a bound paper book holding the names and telephone numbers of contacts, to portable electronic devices that digitally store contact information.

Unfortunately, many of these telephone improvements have not kept pace with the needs of the very young, the elderly, or the handicapped. For the elderly, recent changes have focused primarily on larger displays and buttons to facilitate telephone use for those visually challenged. Another aid targeted to the elderly is the ability to speak on the telephone “hands free,” whereby the telephone includes a built-in speaker and microphone allowing the user to talk on the telephone without physically holding the handset. Telephones with these features are now available commercially to those who would benefit from such devices.

In the area of automatic dialing, prior advances range from a simple redial button or key, to memory recall buttons that require entry of the appropriate speed-dial code in order to retrieve the number. Other attempts have been made to simplify the process of recalling a telephone number and dialing it. For example, a speech enabled automatic dialer has been proposed with a telephone address book stored into a computer where the number can be retrieved and the call placed by the computer. Still other storage approaches vary in complexity and sophistication, from simple electronic index card readers to more sophisticated schemes using bar codes that can be read by an optical wand. In these devices, once a telephone number has been accessed, an electronic circuit is used to dial the number. An automatic dialer was also considered by Basch (U.S. Pat. No. 4,661,976), who revealed a dialing apparatus with an electronic telephone book that can select telephone numbers by first turning to a particular page in a phone book followed by the pressing of an appropriate row or column button to pick one of several numbers listed on one of the two displayed pages. This device does not teach the use of specialized markers embedded into the pages of the telephone book, nor do the pages include provisions for various memory cues such as photographs.

Unfortunately, the automatic dialers as envisioned by Basch '976 and others are complex to use, often presenting to the user a bewildering set of buttons and command sequences to remember that are of little help to those with physical or mental limitations. Moreover, none of the above improvements address the problem of remembering the telephone number of the contact person desired, or providing an easy means of dialing the number. For example, if an elderly person has memory difficulties, remembering a telephone number, (or a speed-dial code), places them at a disadvantage when trying to use the telephone even if equipped with large dialing buttons.

Challenges also occur for users who have developed muscle control problems, whereby the simple operation of pressing a few small recall buttons, typically spaced close together, becomes an increasingly difficult task, often resulting in a misdialed telephone number. People with such difficulties are not limited to the elderly and could include the very young, as well as those with degenerative muscular diseases such as multiple sclerosis. In addition, problems may be encountered trying to locate the telephone number of the contact desired. Most telephone directories are not geared to those with visual, memory, or muscle control difficulties. What is needed is a simple, error-proof method of selecting a telephone number and a means to place the call.

### BRIEF SUMMARY OF THE INVENTION

The primary object of the invention is to provide a self-dialing apparatus that can retrieve a telephone number based on the selected page of a built-in telephone directory.

Another object of the invention is to provide a self-dialing apparatus having a built-in telephone directory with pages that can hold photos, names, or other memory cues that can be associated with specific telephone numbers.

Another object of the invention is to provide a simplified means of dialing a telephone number without having to remember the telephone number or a previously stored speed dial number code.

A further object of the invention is to provide an uncomplicated means of storing a telephone number that is identified with a particular page of a built-in telephone directory.

Yet another object of the invention is to provide the elderly with an easy way of dialing frequent or emergency telephone numbers.

Still yet another object of the invention is to provide young children with an easy way of dialing frequent or emergency telephone numbers.

Another object of the invention is to provide the handicapped with an easy way of dialing frequent or emergency telephone numbers.

Yet another object of the invention is to retrieve and dial a telephone number by simply turning the pages of an attached telephone directory to a particular photo, name, or other memory cue and pressing a dial button.

Still yet another object of the invention is to store and retrieve a long string of numbers so that discount long distance telephone numbers can easily be used.

Another object of the invention is to incorporate a single button to dial a telephone number.

Another object of the invention is to incorporate two additional buttons that can be used to store a new telephone number.

A further object of the invention is to provide an automatic dialer that works with the user's existing telephone.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, an apparatus is disclosed for automatically storing and dialing telephone numbers based on the selection of a particular page of an attached telephone directory. The dialing apparatus includes a means of connecting to a telephone and a telephone line service. In addition, the apparatus includes an attached telephone directory with pages that can accommodate photos, names, or other memory cue information that can be associated with a particular telephone number. Moreover, each page of the telephone directory incorporates some form of page marker. The dialing apparatus is further comprised of a first circuit capable of sensing the page marker and thereby determine which page in the directory is being viewed by the user. The first circuit can then associate a viewed page with a particular telephone number. A second circuit is provided that can store a telephone number sequence which has been received from an attached, or built-in telephone, and associate it with a page number as identified by the first circuit. The apparatus also includes a third circuit capable of dialing a telephone number. Dialing is accomplished by a first button, that when pushed, initiates the dialing of a telephone number which corresponds to the selected page in the directory. The dialing apparatus also incorporates a second and third button that starts and ends the storage of a telephone number sequence.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of one embodiment of the self-dialing apparatus shown attached to a telephone and telephone line service.

FIG. 2 is a partially transparent view showing the internal built-in markers and sensor sections of the self-dialing apparatus of FIG. 1.

FIG. 3 is a schematic diagram illustrating a magnetic disk page marker and sensor arrangement in accordance with one embodiment as shown in FIG. 2.

FIG. 4 is another embodiment of a capacitive-based foil page marker and sensor arrangement for the self-dialing apparatus of FIG. 1.

FIG. 5 is a schematic diagram illustrating the capacitive-based page marker and sensing portion of the invention in accordance with the embodiment of FIG. 4.

FIG. 6A is a schematic diagram illustrating an RF antenna circuit page marker and combined swept RF transmitter and receiver sensing portion of the invention.

FIG. 6B is a schematic diagram illustrating a magnetorestrictive page marking element and combined pulsed magnetic field transmitter and receiver sensing portion of the invention.

FIG. 6C is a schematic diagram illustrating a high magnetic permeability page marking element and combined electromagnetic field page marker and sensing portion of the invention.

FIG. 7 is a schematic diagram illustrating an optical-based page marker and sensing portion of the invention in accordance with another embodiment of the invention of FIG. 1.

FIG. 8 is a schematic diagram illustrating a rotary switch page marker and sensing arrangement in yet another embodiment of the invention of FIG. 1.

FIG. 9 is a flow chart of the operating components of the self-dialing apparatus of FIG. 1.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

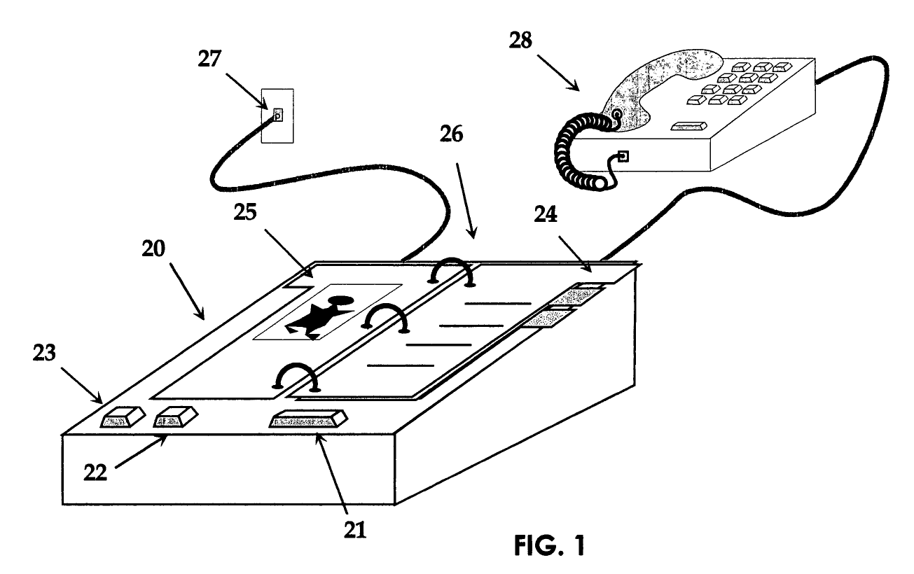

The preferred embodiment of the automatic telephone dialer apparatus is indicated by reference number 20 in FIG. 1 and shows connections to an attached telephone 28 and telephone line service at 27. The attached telephone is used for normal voice communications as well as a means of sending telephone number information to the dialing apparatus through its keypad. The telephone number information can be in the form of dial tones or pulses according to the standard practice. The dialing apparatus 20 is comprised of an attached telephone directory 26 and a first button 21, as well as a second button 22 and third button 23. The first button is generally used to initiate the dialing of a telephone number, while buttons 22 and 23 are used to start and end the storage of a telephone number sequence.

The telephone directory 26 is comprised of a plurality of pages, of which pages 24 and 25 are identified in FIG. 1. In a typical application, although by no means limited to this arrangement, a name would be entered on one of the pages facing the viewer, say page 24, and a photograph or other memory cue, placed on the opposing side (back of page 25). In this way, the user has a quick visual means of selecting a desired telephone number by simply turning the pages of the directory until a visual cue is found. By way of built-in markers mounted into each page of the directory, the dialing apparatus is furthermore capable of associating a telephone number with each page being viewed. In the preferred embodiment, programming the dialing apparatus such that a given page is associated with a desired telephone number is accomplished by first pressing the second button 22, followed by the entry of a telephone number that was received from telephone 28 and then terminating the storage sequence by pressing the third button 23. These steps would save the entered telephone number and associate it with the particular page (and back of the opposing page) being viewed in the telephone directory 26.

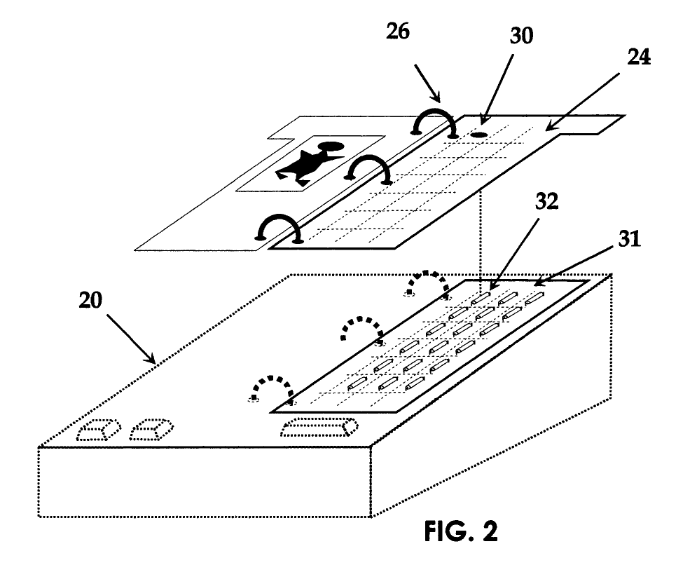

The means by which the dialing apparatus 20 is able to identify which page in the directory is being viewed is explained in FIG. 2. Depicted in FIG. 2 is a transparent view of the dialing apparatus 20 revealing a circuit board 31 with an attached page marker sensor 32. Also shown in FIG. 2 is the telephone directory 26 elevated above the dialing apparatus 20 with page 24 identified along with a page marker indicated by 30. In the preferred embodiment, each page in the telephone directory would have a page marker located in a different location on the page. Aligned with each of these other marker locations, there would be a marker sensor positioned appropriately on the underlying sensor board 31. Therefore, depending on which pages are turned, a unique set of marker sensors would be activated and consequently each page in the telephone directory could be identified by the appropriate circuitry.

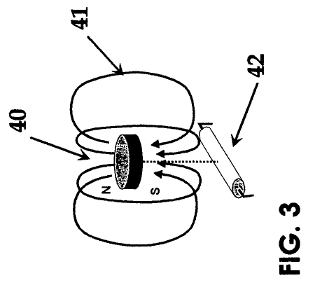

A specific example of a page marker and sensor pair is illustrated in FIG. 3, which shows a small disk magnet 40 with field lines 41 and a magnetic field sensor 42. In the preferred embodiment, the disk magnet 40 would be inserted inside the telephone directory page and the magnetic field sensor would be mounted onto board 31 housed within the dialing apparatus 20. In the preferred embodiment the magnetic sensor would be a magnetic reed switch.

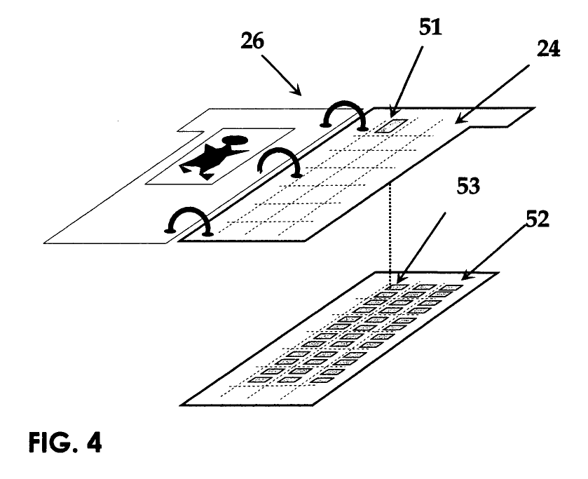

It is evident that the page marker and sensor pair is by no means limited to a magnetic-based arrangement. FIG. 4 illustrates another example of a page marker and sensor pair. As shown in FIG. 4, labeled page 24 incorporates a small electrically conductive foil pattern 51. Corresponding to this foil pattern there would be a sensor 53 located on circuit board 52 that would be housed within the dialing apparatus 20. Again, each page in the telephone directory would have a foil pattern situated in a different location with a corresponding sensor.

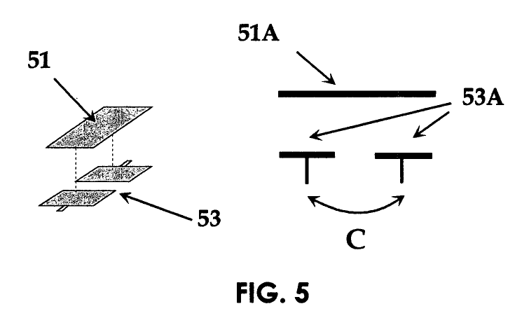

In one example, foil marker sensor 53 could be a capacitive sensor as depicted in FIG. 5. The foil pieces form a split capacitor arrangement as shown by 51A and 53A such that a capacitance C could be measured between the two leads. The magnitude of the capacitance would vary with the spacing between plate 51A and sensor plates 53A. Circuits that can measure capacitance are well known to those skilled in the art of analog circuit design and could be used to form what is essentially a proximity detector. Depending on which pages are turned in the telephone directory, a unique set of capacitive sensors would be activated, thereby providing a means of identifying the particular page being viewed.

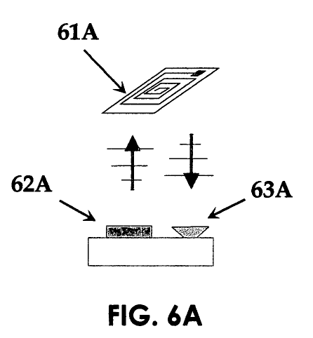

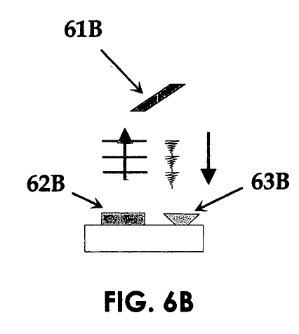

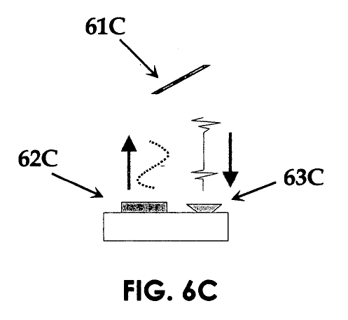

In accordance with yet another embodiment of a marker-sensor pair, refer to FIG. 6A where the page marker is a small RF (Radio Frequency) coil antenna circuit 61A and the marker sensor is a short range RF sweeping transmitter and receiver circuit denoted by reference numbers 62A and 63A respectively. RF circuits that can detect the presence of small RF coil antennas are well known in the retail market business where they are used to tag and identify merchandise. A similar scheme could be used here except the RF transmitter and receiver range would be very short so as to only detect those elements directly above the transmitting and receiving circuit. Depending on the number of pages that were positioned over the sensing circuit, a unique set of RF antenna coils would be activated by the transmitter circuit 62A, thereby providing a means of identifying the particular page being viewed.

Turning to FIG. 6B, we show in accordance with the present invention a further embodiment of a marker-sensor pair. In FIG. 61B the page marker is a small resonating magnetorestrictive element and the marker sensor is a short range magnetic pulse transmitter 62B and a signal receiver circuit 63B that can detect the presence of the magnetorestrictive element through its characteristic resonant frequency. As with the RF tagging circuits, this technology is well known in the retail market business where the magnetorestrictive elements are used to tag and identify merchandise. A similar scheme could be used here only the magnetic pulse transmitter and receiver range would be very short so as to only activate those elements directly above the transmitting and receiving circuit.

FIG. 6C illustrates a further embodiment of a marker-sensor pair. In FIG. 61C the page marker is a small high magnetic permeability element and the marker sensor is a short distance electromagnetic field generator 62C and a signal receiver circuit 63C that can detect the presence of the high permeability element as it goes in and out of magnetic saturation. As with the RF tagging circuits, this technology is also well known in the retail market business where the high permeability elements are used to tag and identify merchandise. A similar scheme could be used here except the electromagnetic generator and receiver range would be very short so as to only activate those elements directly above the transmitting and receiving circuit.

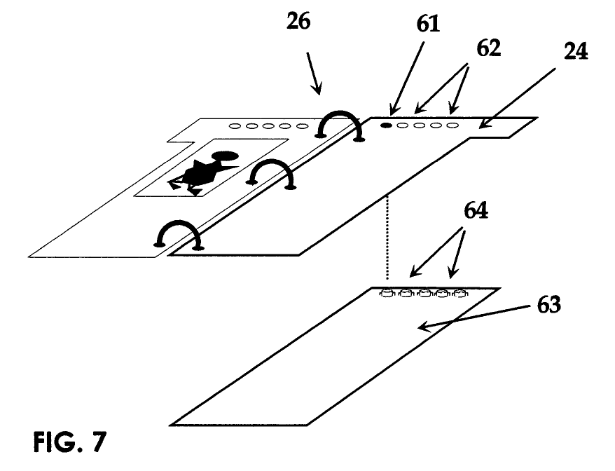

In yet still another embodiment as illustrated in FIG. 7, the page marker 61 could be an optically reflective or absorptive coating placed in specific areas on the underside of representative page 24 of the telephone directory 26. Corresponding to each optical pattern there would be a sensor comprised of an optical transmitter and receiver 64 located on circuit board 63 capable of sending and detecting either a reflected, or non-reflected optical signal. Each page in the telephone directory would have a particular optical coating pattern located in different locations. For this arrangement, holes 62 would have to be cut into previous pages to allow the transmitted light from one of the sensors 64 placed on the circuit board 63 to reach the markers on other pages located above. Circuits that can optically detect the presence of surfaces are well known to those skilled in the art of optical proximity sensors. Depending on the number of pages that were positioned over the sensing circuit, a unique set of optical sensors would be activated, thereby providing a means of identifying the page being viewed.

Although not explicitly shown, the marker-sensor pair could have a page marker comprised of an acoustically reflective or absorptive element mounted into the telephone directory page with the marker sensor comprised of an acoustic transmitter and receiver capable of sending and detecting a reflected or non-reflected acoustic signal.

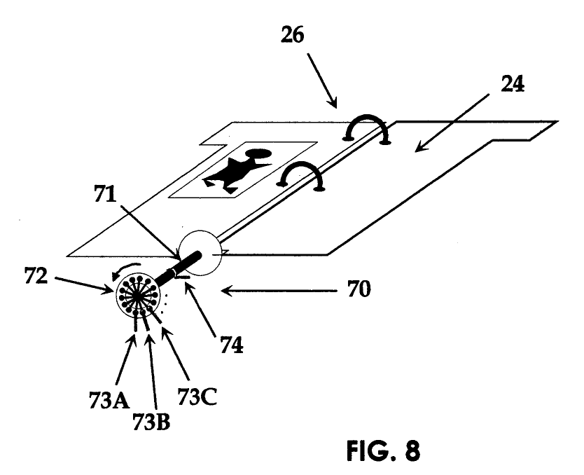

In keeping with the spirit of the present invention, a further means of identifying pages in the attached telephone directory is displayed in FIG. 8 comprising a telephone directory 26 and rotary switch assembly 70. In this arrangement, each page is mechanically attached though a connector 71 to a rotary switch 72 such that as each page is turned, the rotary switch advances to a new position. As each page is turned, a new electrical path is made through contacts 74 and 73A, 73B, 73C, etc, with the exact path being dependent on the particular page being viewed. Other electrical switch contact arrangements beyond the one depicted in FIG. 8 can be envisioned to those skilled in the art of mechanical switch assemblies.

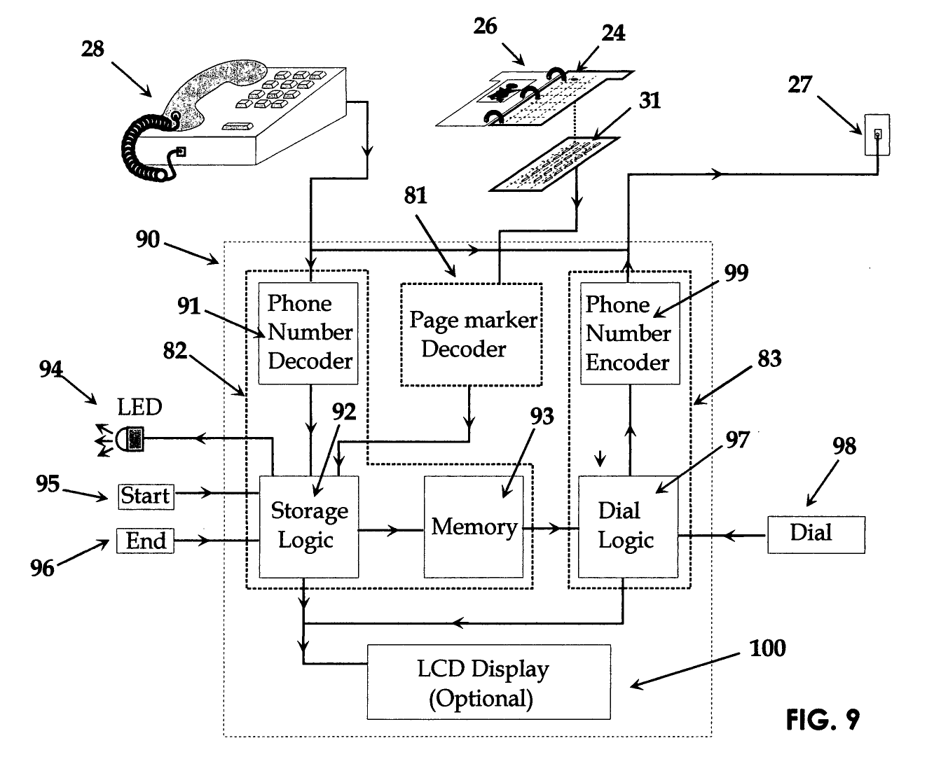

FIG. 9 shows a schematic flow chart 90 of the primary circuit operations of the dialing apparatus 20 of FIG. 1. Enclosed within flow chart 90 and outlined with heavy dotted lines is a first circuit 81, a second circuit 82, and a third circuit 83. A telephone 28 is connected to the telephone number decoder block 91 and telephone number encoder block 99 as well as the outside telephone line service at 27. The attached telephone directory 26 shows page 24 being detected by a sensor board 31 whose output goes to the first circuit 81, which is the page marker decoder block. Circuit 81 sends decoded page marker signals to the storage logic block 92. Block 91 within the second circuit 82 decodes telephone number information from telephone 28 in the form of either dial tones, or pulses, and sends it to the storage logic block 92. Besides functional blocks 91 and 92, circuit 82 also contains a memory block 93, which stores the decoded telephone numbers. Connected to storage logic block 92, are buttons 95 and 96. Button 95 begins the storage of a telephone number and corresponds to the second button 22 illustrated in FIG. 1. Button 96 ends the storage process of a telephone number and corresponds to the third button 23 depicted in FIG. 1. The third circuit 83 contains a telephone number encoder block 99 and a dial logic block 97. Connected to the dial logic block 97 is a dial button 98, which initiates the dialing out of a telephone number and corresponds to the first button 21 illustrated in FIG. 1.

Additional components are also depicted in FIG. 9. An LED 94 can be linked to the storage logic block 92 to provide a visual feedback to the user that a telephone number storage operation is in progress. Additionally, an LCD 100 display can be included into the dialing apparatus to display the telephone number being dialed, or the telephone number being entered for storage. Although we have shown the telephone 28 as a separate device, it could equally have been integrated directly into the dialing unit if desired.

Prior to its use as an automatic dialer, the apparatus must first be programmed with telephone numbers. Programming can be done by the primary user, or by someone else, if the primary user is not capable. To begin, each page (and backside of the opposing page) of the telephone directory 26 of FIG. 9 would have attached memory cue information, such as a large printed name and photograph of the party that the user wants placed into the telephone directory. After all pages have been provided with memory cues, the user would turn to a page in the telephone directory and then pick up the telephone 28 and press the “Start” button 95 followed by the entry of the entire telephone number (through the keypad of telephone 28) of the party currently being viewed on the telephone directory page. Once the number has been entered, the “End” button 96 would be pressed. The number just entered is automatically stored into the memory block 93 and is now associated with the page currently being viewed by way of the page decoder block 81. The same process is repeated for each new page in the telephone directory. Once all of the desired pages have been programmed, the automatic dialer is ready for use.

To place a call, the user would page through the attached directory 26 until the image, name, or whatever memory cue information is being used is found. Leaving the directory opened to the desired page, the user simply picks up the telephone 28 and presses the “Dial” button 98. The page decoder circuit 83 uses the address information of storage logic block 92 and memory block 93 to extract the stored telephone number of the party corresponding to the page being viewed. The telephone number is encoded by block 99 and sent out onto the external telephone line 27. Once the dialed number has been sent out, and the receiving party has picked up, the user can converse over the telephone 28 as he or she would normally do had they dialed the telephone number manually.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An apparatus for automatically dialing a telephone number comprising:
an attached telephone directory with a plurality of pages that can accommodate photographs, names, or other memory cue information, and wherein each page of said plurality of pages has a built-in marker to uniquely identify each page;
a first circuit capable of detecting the built-in page marker;
a second circuit capable of receiving and storing a series of telephone numbers;
a third circuit capable of dialing a telephone number;
a first button that when pushed initiates the dialing of a telephone number;
a second button that when pushed starts the storage of a telephone number sequence;
a third button that when pushed ends the storage of a telephone number sequence;
a means of connecting to a telephone; and
a means of connecting to a telephone line service.

2. The apparatus for automatically dialing a telephone number of claim 1 wherein the first circuit incorporates a sensor that can detect the built-in page marker and thereby determine which page is being viewed.

3. The apparatus for automatically dialing a telephone number of claim 2 wherein the built-in page marker and sensor comprise a compatible marker-sensor pair wherein the sensor only detects the particular type of built-in page marker used.

4. The apparatus for automatically dialing a telephone number of claim 1 wherein the second circuit receives and stores a telephone number transmitted from the telephone that is connected to the apparatus.

5. The apparatus for automatically dialing a telephone number of claim 1 wherein the second circuit associates each stored telephone number with a given page in the attached telephone directory.

6. The apparatus for automatically dialing a telephone number of claim 1 wherein the third circuit sends the telephone number as a series of dialing pulses onto the connected telephone line service.

7. The apparatus for automatically dialing a telephone number of claim 1 wherein the third circuit sends the telephone number as a series of dial tones onto the connected telephone line service.

8. The apparatus for automatically dialing a telephone number of claim 1 wherein the first button when pushed initiates the dialing of a telephone number corresponding to a selected page in the telephone directory.

9. The apparatus for automatically dialing a telephone number of claim 1 wherein the second button when pushed starts the storage of a telephone number sequence that is received from the telephone that is connected to the apparatus.

10. The apparatus for automatically dialing a telephone number of claim 1 wherein the third button when pushed ends the storage of a telephone number sequence being received from the telephone that is connected to the apparatus.

11. The apparatus for automatically dialing a telephone number of claim 3 wherein the compatible marker-sensor pair is a built-in page marker comprised of a small magnet mounted into the telephone directory page and the sensor is a magnetic field sensor.

12. The apparatus for automatically dialing a telephone number of claim 3 wherein the compatible marker-sensor pair is a built-in page marker comprised of a small magnet mounted into the telephone directory page and the sensor is a magnetic reed switch.

13. The apparatus for automatically dialing a telephone number of claim 3 wherein the compatible marker-sensor pair is a built-in page marker comprised of an electrically conductive foil mounted into the telephone directory page and the sensor is a capacitive proximity sensor.

14. The apparatus for automatically dialing a telephone number of claim 3 wherein the compatible marker-sensor pair is a built-in page marker comprised of an electrical radio frequency antenna circuit mounted into the telephone directory page and the sensor is a short range radio frequency sweeping circuit that can detect the presence of the antenna circuit.

15. The apparatus for automatically dialing a telephone number of claim 3 wherein the compatible marker-sensor pair is a built-in page marker comprised of a magnetorestrictive element mounted into the telephone directory page and the sensor is a short range magnetic pulse transmitter and signal receiver circuit that can detect the presence of the magnetorestrictive element.

16. The apparatus for automatically dialing a telephone number of claim 3 wherein the compatible marker-sensor pair is a built-in page marker comprised of a high magnetic permeability element mounted into the telephone directory page and the sensor is a short range electromagnetic field transmitter and receiver circuit that can detect the presence of the high magnetic permeability element.

17. The apparatus for automatically dialing a telephone number of claim 3 wherein the compatible marker-sensor pair is a built-in page marker comprised of an acoustically reflective or absorptive element mounted into the telephone directory page and the sensor is comprised of an acoustic transmitter and receiver capable of sending and detecting a reflected or non-reflected acoustic signal.

18. The apparatus for automatically dialing a telephone number of claim 3 wherein the compatible marker-sensor pair is a built-in page marker comprised of a reflective or absorptive optical film mounted into the telephone directory page and the sensor is comprised of an optical sensor capable of sending and detecting a reflected or non-reflected optical signal.

19. The apparatus for automatically dialing a telephone number of claim 1 wherein the first circuit is able to determine the position of an electrical switch with a plurality of contacts mechanically linked to each page of the telephone directory such that each position of the switch corresponds to a different page in the attached telephone directory.

20. An apparatus for automatically dialing a telephone number of claim 1 wherein the means of connecting to a telephone is provided by a telephone that is built into the apparatus.
